(19) United States
(12) Patent Application Publication
(10) Pub. No.: US 2022/0128067 A1
(43) Pub. Date: Apr. 28, 2022

(54) ROTARY MACHINE AND GEARED COMPRESSOR

(71) Applicant: MITSUBISHI HEAVY INDUSTRIES COMPRESSOR CORPORATION, Tokyo (JP)

(72) Inventors: Nobuyori Yagi, Tokyo (JP); Akihiro Nakaniwa, Tokyo (JP); Takashi Oda, Hiroshima-Shi (JP); Minoru Shimatani, Hiroshima-Shi (JP); Jumpei Karasuda, Hiroshima-Shi (JP)

(73) Assignee: MITSUBISHI HEAVY INDUSTRIES COMPRESSOR CORPORATION, Tokyo (JP)

(21) Appl. No.: 17/470,577

(22) Filed: Sep. 9, 2021

(30) Foreign Application Priority Data
Oct. 22, 2020 (JP) 2020-177185

(51) Int. Cl. F04D 29/62; F04D 25/16; F04D 29/053; F04D 17/10

(52) U.S. Cl. CPC F04D 29/624; F04D 17/10; F04D 29/053; F04D 25/163

(57) ABSTRACT

A rotary machine according to at least one embodiment is configured such that, in a region on an opposite side to a thrust collar across a key in an axial direction, a defective portion is provided on one of an outer circumferential surface of a shaft, or a surface of the shaft along a radial direction or a surface of a holding member along the radial direction, or at least a part of a section having the surface along the radial direction is formed by a material having a Young's modulus lower than a Young's modulus in another section.

### TECHNICAL FIELD

The present disclosure relates to a rotary machine and a geared compressor.

### BACKGROUND

For example, like a geared compressor, a rotary machine is known which is configured such that a driving force from a driving source is transmitted at an increased or decreased speed when transmitted. Such a rotary machine may be configured such that, for example, gears mounted on a shaft mesh with each other, and the driving force is transmitted between the meshing gears. In this case, it is necessary to prevent a relative position of the meshing gears from shifting in the axial direction of the shaft. As an example of such a configuration, for example, a thrust collar is disposed on a shaft where one of the two meshing gears is mounted, and the thrust collar is brought into contact with a side surface of the other gear, thereby regulating so the relative position of the two gears does not shift in the axial direction (for example, see Patent Document 1).

### CITATION LIST

### Patent Literature

### Patent Document 1: JPH9-269044A

### SUMMARY

In Patent Document 1 described above, in a case where the thrust collar is fixed to the shaft (pinion shaft) by, for example, shrink fitting, if a fastening force between the thrust collar and the pinion shaft by shrink fitting is insufficient, a relative position of the thrust collar to the pinion shaft shifts in the axial direction, which may shift the relative position of the two gears in the axial direction.

However, if, for example, an axial length of a fastening section is increased to obtain a sufficient fastening force, an axial length of the pinion shaft increases, which is unfavorable in terms of shaft variation, possible upsizing of the rotary machine, and the like.

In view of the above, an object of at least one embodiment of the present invention is to suppress a shift of the thrust collar in the axial direction while suppressing an increase in shaft length in the rotary machine.

(1) A rotary machine according to at least one embodiment of the present disclosure includes a shaft extending along an axial direction, a thrust collar disposed on an outer circumferential side of the shaft, a key which engages with a key groove formed in an outer circumferential surface of the shaft and is disposed adjacent to the thrust collar in the axial direction, and a holding member located on an opposite side to the thrust collar across the key in the axial direction, for holding the key from radially outside. In a region on the opposite side to the thrust collar across the key in the axial direction, a defective portion is provided on one of the outer circumferential surface of the shaft, or a surface of the shaft along a radial direction or a surface of the holding member along the radial direction, or at least a part of a section having the surface along the radial direction is formed by a material having a Young's modulus lower than a Young's modulus in another section.

(2) A geared compressor according to at least one embodiment of the present disclosure has the configuration according to the above configuration (1).

According to at least one embodiment of the present disclosure, it is possible to suppress a shift of a thrust collar in the axial direction while suppressing an increase in shaft length in a rotary machine.

### BRIEF DESCRIPTION OF DRAWINGS

FIG. 1 is a partial exploded view showing the schematic configuration of a compressor according to some embodiments.

FIG. 2 is a view for describing prevention of a shift in relative position of a wheel gear to a pinion gear of the compressor according to an embodiment.

FIG. 3A is a partial enlarged view of FIG. 2.

FIG. 3B is a view for describing prevention of the shift in relative position of the wheel gear to the pinion gear of the compressor according to another embodiment, and is a view corresponding to the partial enlarged view of FIG. 2.

FIG. 3C is a view for describing prevention of the shift in relative position of the wheel gear to the pinion gear of the compressor according to another embodiment, and is a view corresponding to the partial enlarged view of FIG. 2.

FIG. 3D is a view for describing prevention of the shift in relative position of the wheel gear to the pinion gear of the compressor according to another embodiment, and is a view corresponding to the partial enlarged view of FIG. 2.

FIG. 4 is a cross-sectional view of a shaft taken along arrow IV-IV in FIG. 2 according to an embodiment.

FIG. 5 is a perspective view of the shaft according to another embodiment.

### DETAILED DESCRIPTION

Embodiments of the present disclosure will be described below with reference to the accompanying drawings. It is intended, however, that unless particularly identified, dimensions, materials, shapes, relative positions and the like of components described or shown in the drawings as the embodiments shall be interpreted as illustrative only and not intended to limit the scope of the present disclosure.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same”, “equal”, and “uniform” shall not be construed as indicating only the state in which the feature is strictly equal, but also includes a state in which there is a tolerance or a difference that can still achieve the same function.

Further, for instance, an expression of a shape such as a rectangular shape or a tubular shape shall not be construed as only the geometrically strict shape, but also includes a shape with unevenness or chamfered corners within the range in which the same effect can be achieved.

On the other hand, the expressions “comprising”, “including”, “having”, “containing”, and “constituting” one constituent component are not exclusive expressions that exclude the presence of other constituent components.

(Geared Compressor 20)

First, a compressor which is an example of a rotary machine according to some embodiments will be described.

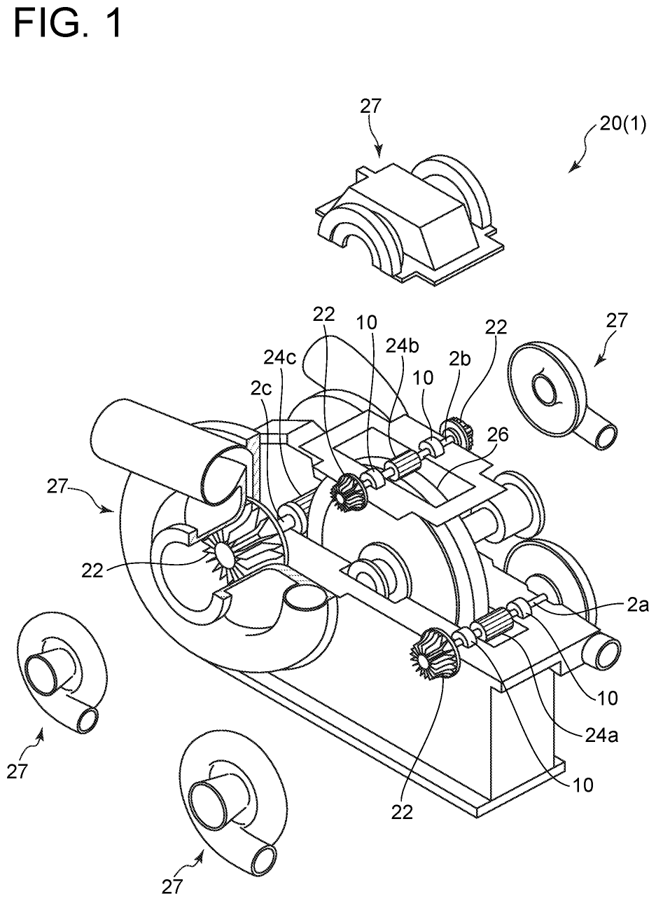

FIG. 1 is a partial exploded view showing the schematic configuration of the compressor according to some embodiments. As illustrated in the drawing, a compressor 20 which is a rotary machine 1 according to some embodiments is a geared compressor that includes rotational shafts (shafts) 2a to 2c extending along the axial direction, impellers 22 mounted on both end portions of each of the shafts 2a to 2c, pinion gears (driven gears) 24a to 24c, respectively, mounted on the shafts 2a to 2c, a wheel gear (driving gear) 26 for rotary driving the pinion gears 24a to 24c, and a plurality of bearing devices 10 for, respectively, supporting the shafts 2a to 2c. The shafts 2a to 2c, the impellers 22, the pinion gears 24a to 24c, and the wheel gear 26 are housed in a casing 27.

FIG. 1 is a partial exploded view where a part of the casing 27 is exploded. The wheel gear 26 is connected to, for example, an output shaft of a driving source (not shown) such as a motor, and is rotary driven by the driving source. The pinion gears 24a to 24c, respectively, mounted on the shafts 2a to 2c are disposed to mesh with the wheel gear 26 and are rotary driven by the wheel gear 26. If the pinion gears 24a to 24c are rotary driven by the wheel gear 26, the shafts 2a to 2c are rotary driven with the pinion gears 24a to 24c, respectively. Consequently, the respective impellers 22 mounted to the shafts 2a to 2c rotate, compressing a fluid.

In the compressor 20 shown in FIG. 1, the pinion gears 24a to 24c mesh with the wheel gear 26 at different positions. For example, the pinion gears 24a and 24c are disposed such that center axes of the corresponding shafts 2a and 2c are located on a diameter of the wheel gear 26 extending in the horizontal direction, and mesh with the wheel gear 26 at the position of the diameter of the wheel gear 26 extending in the horizontal direction. Further, for example, the pinion gear 24b is disposed such that a center axis of the corresponding shaft 2b is located on the diameter of the wheel gear 26 extending in the vertical direction, and meshes with the wheel gear 26 at the position of the diameter of the wheel gear 26 extending in the vertical direction.

In the following description, if the shafts 2a to 2c need not be described in distinction from each other, they will simply be referred to as the shaft 2 by omitting the alphabets in reference characters. Likewise, if the pinion gears 24a to 24c need not be described in distinction from each other, they will simply be referred to as the pinion gear 24 by omitting the alphabets in reference characters.

Further, in the following description, the axial direction of the shaft 2 which is a direction along a center axis AX of the shaft 2 may simply be referred to as the axial direction. Likewise, in the following description, the circumferential direction of the shaft 2 centered on the center axis AX of the shaft 2 may simply be referred to as the circumferential direction, and the radial direction of the shaft 2 centered on the center axis AX of the shaft 2 may simply be referred to as the radial direction.

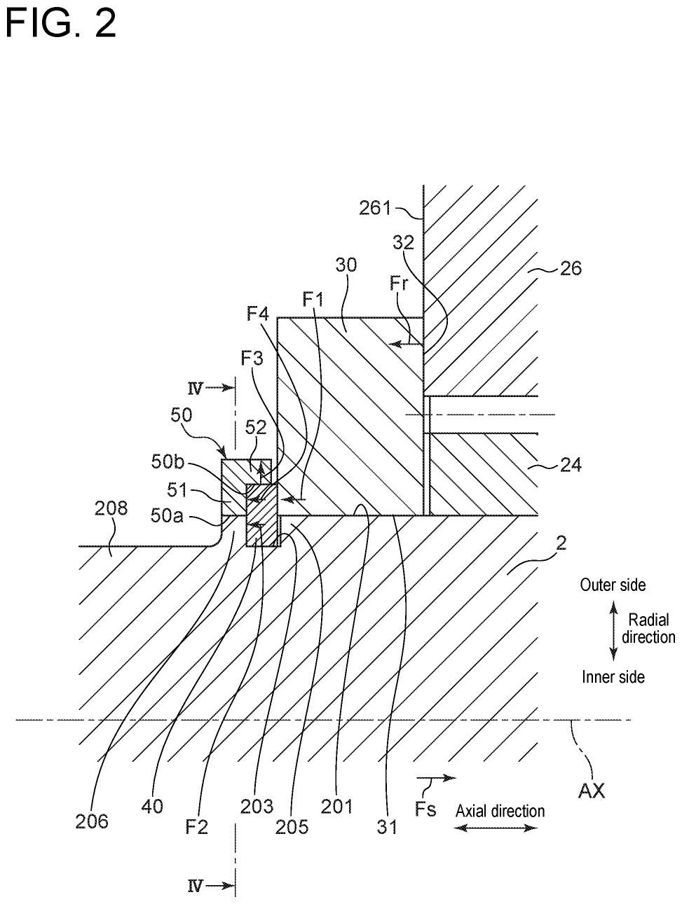

FIG. 2 is a view for describing prevention of a shift in relative position of the wheel gear to the pinion gear of the compressor according to an embodiment. FIG. 2 represents a cross-section of a part of the wheel gear 26 and the pinion gear 24, and a part of the shaft 2 mounted with the pinion gear 24, taken along the center axis AX of the shaft 2.

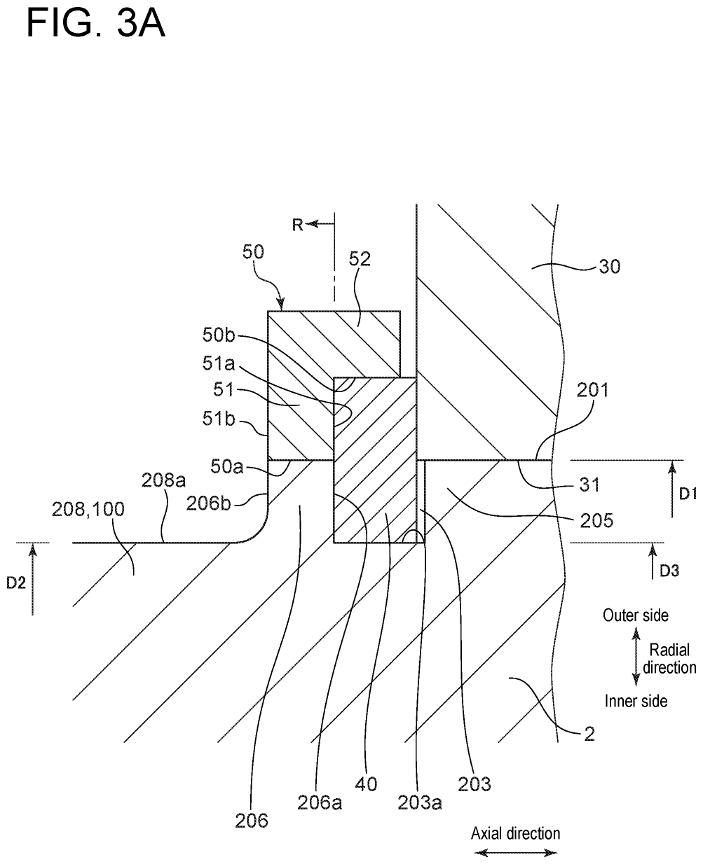

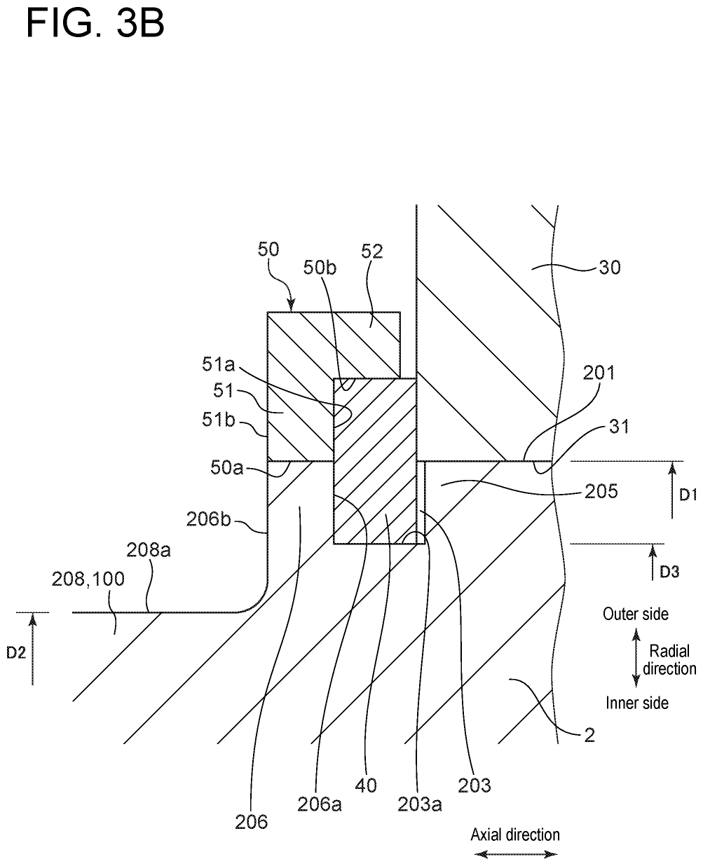

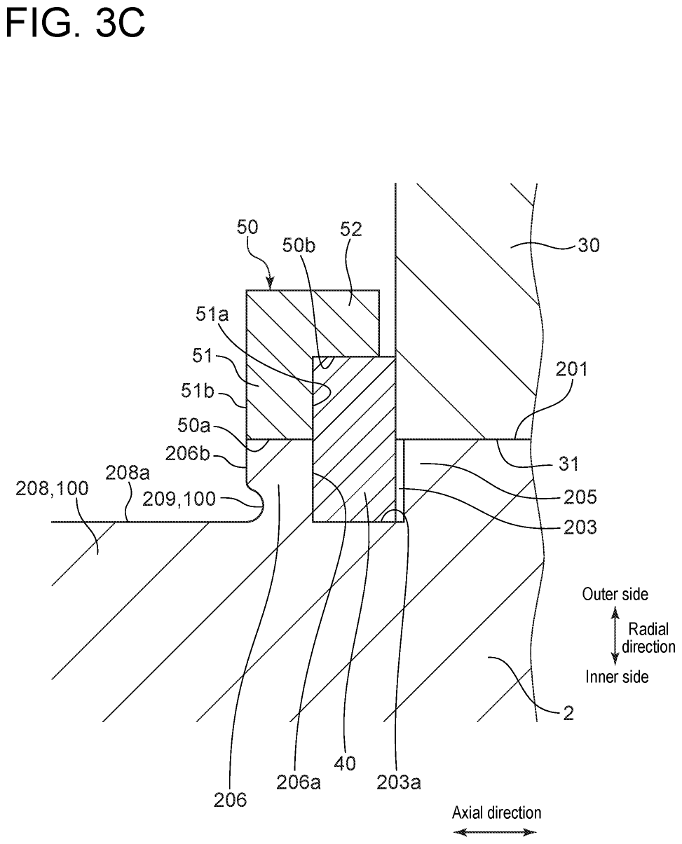

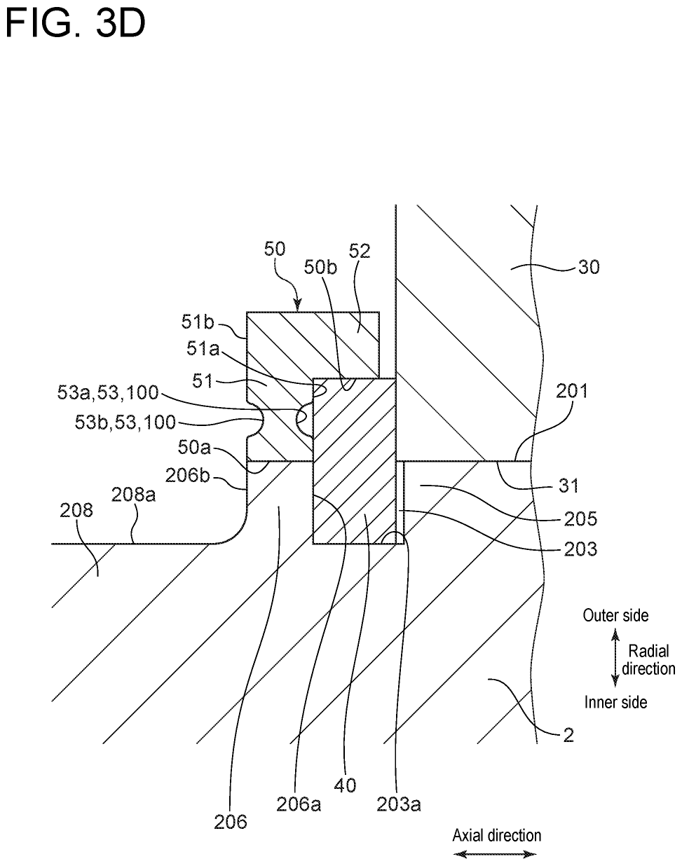

FIG. 3A is a partial enlarged view of FIG. 2.

FIGS. 3B, 3C, and 3D are each a view for describing prevention of the shift in relative position of the wheel gear to the pinion gear of the compressor according to another embodiment, and is a view corresponding to the partial enlarged view of FIG. 2.

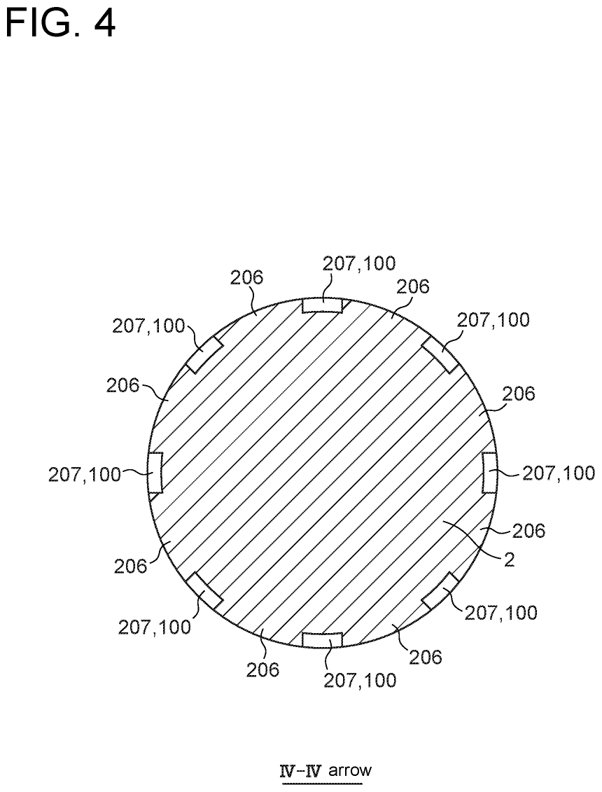

FIG. 4 is a cross-sectional view of the shaft taken along arrow IV-IV in FIG. 2 according to an embodiment.

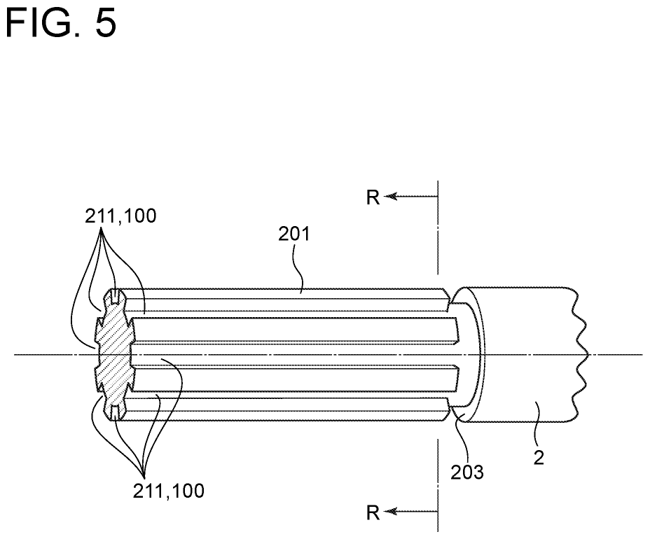

FIG. 5 is a perspective view of the shaft according to another embodiment.

As shown in FIGS. 2, 3A, 3B, 3C, and 3D, the compressor 20 according to some embodiments includes the shaft 2 extending along the axial direction, that is, an extension direction of the center axis AX, a thrust collar 30 disposed on an outer circumferential side of the shaft 2, a key 40 which engages with a key groove 203 formed in an outer circumferential surface 201 of the shaft 2 and is disposed adjacent to the thrust collar 30 in the axial direction, and a holding member 50 located on an opposite side to the thrust collar 30 across the key 40 in the axial direction, for holding the key 40 from radially outside.

In the compressor 20 according to some embodiments, the pinion gear 24 may be fixed to the shaft 2 by shrink fitting or may be formed integrally with the shaft 2.

In the compressor 20 according to some embodiments, the thrust collar 30 is, for example, a disc-shaped member with a through hole 31 penetrating along the axial direction. The thrust collar 30 is inserted with the shaft 2 through the through hole 31, and is disposed on a lateral side of the pinion gear 24 such that one side surface 32 faces the side surface of the pinion gear 24. Although not illustrated in FIGS. 2, 3A, 3B, 3C, and 3D, the thrust collars 30 are, respectively, disposed on lateral sides of both side surfaces of the pinion gear 24. The thrust collar 30 is fixed to the shaft 2 by shrink fitting, for example.

In the compressor 20 according to some embodiments, the key groove 203 is formed to extend in the circumferential direction in the outer circumferential surface 201 of the shaft 2. The key groove 203 may be formed over the entire circumference of the shaft 2, or a plurality of key grooves 203 may be formed to be disposed apart from each other in the circumferential direction.

Wall portions 205, 206 constituting the key groove 203 include the first wall portion 205 located on the side of the thrust collar 30 across the key 40 in the axial direction, that is, on the right side in FIG. 2, and the second wall portion 206 located on the opposite side to the thrust collar 30 across the key 40 in the axial direction, that is, on the left side in FIG. 2. In the following description, in the first wall portion 205 and the second wall portion 206, wall surfaces defining the key groove 203 will be referred to as key groove wall surfaces. In particular, the key groove wall surface of the second wall portion 206 may be referred to as a second key groove wall surface 206a (see FIG. 3A).

The second wall portion 206 may be formed over the entire circumference of the shaft 2, but as shown in FIG. 4, a plurality of second wall portions 206 may be formed to be disposed apart from each other in the circumferential direction. If the second wall portions 206 are formed to be disposed apart from each other in the circumferential direction, a region between the two second wall portions 206 adjacent to each other in the circumferential direction will be referred to as a wall defective region 207.

In the compressor 20 according to some embodiments, the key 40 is disposed to engage with the key groove 203. The key 40 is a member having a partial annular shape as viewed in the axial direction and in the shaft 2, a plurality of keys 40 are disposed along the circumferential direction.

In the compressor 20 according to some embodiments, the holding member 50 is a ring-shaped member and has a shape where two holes different in diameter are ranged along the axial direction. Of the two holes different in diameter, a hole having a smaller diameter will be referred to as a first hole 50a, and a hole having a larger diameter will be referred to as a second hole 50b. That is, the holding member 50 according to some embodiments has a shape where a ring-shaped first region 51 forming the first hole 50a and a ring-shaped second region 52 forming the second hole 50b are ranged in the axial direction.

In the compressor 20 according to some embodiments, the holding member 50 has a first end surface 51a and a second end surface 51b both of which are surfaces of the first region 51 along the radial direction. The first end surface 51a is located on the side of the thrust collar 30 in the axial direction, that is, on the right side in FIG. 3A, and the second end surface 51b is located on the opposite side to the thrust collar 30 in the axial direction, that is, on the left side in FIG. 3A.

For example, in the compressor 20 shown in FIG. 1, a thrust force acts on the shaft 2 by, for example, a difference in force acting on the impellers 22 when the impellers 22 rotate to suck a fluid between the two impellers 22 mounted on both ends of the shaft 2. The thrust force tends to increase in a transient state such as when an operation of the compressor 20 is started and stopped. Further, for example, if the wheel gear 26 and the pinion gear 24 are helical gears, a thrust force arising from a helical angle of a tooth is generated in the wheel gear 26 and the pinion gear 24 when power is transmitted between the wheel gear 26 and the pinion gear 24.

Thus, in the compressor 20 shown in FIG. 1, in order to prevent a relative position of the wheel gear 26 to the pinion gear 24 meshing with the wheel gear 26 from shifting in the axial direction of the shaft 2, the side surface 32 of the thrust collar 30 is brought into sliding contact with a side surface 261 of the wheel gear 26, thereby regulating the axial positional shift between the shaft 2 and the wheel gear 26.

As described above, for example, since the relatively large thrust force acts on the shaft 2 in the transient state, in order to prevent the relative position of the wheel gear 26 to the pinion gear 24 meshing with the wheel gear 26 from shifting in the axial direction of the shaft 2, it is important for the thrust collar 30 not to cause the positional shift with respect to the shaft 2 in the axial direction. If a fastening force between the thrust collar 30 and the shaft 2 is insufficient, the relative position of the thrust collar 30 to the shaft 2 shifts in the axial direction, which may shift the relative position of the wheel gear 26 to the pinion gear 24 in the axial direction.

However, if, for example, an axial length of a fastening section between the thrust collar 30 and the shaft 2 is increased to obtain a sufficient fastening force between the thrust collar 30 and the shaft 2, an axial length of the shaft 2 increases, which is unfavorable in terms of shaft variation, possible upsizing of the compressor 20, and the like.

Thus, in the compressor 20 according to some embodiments, axial movement of the thrust collar 30 is regulated by the key 40 which engages with the key groove 203 formed in the outer circumferential surface 201 of the shaft 2 and is disposed adjacent to the thrust collar in the axial direction. In the compressor 20 according to some embodiments, in order to prevent the key 40 engaged with the key groove 203 from falling off the key groove 203, the holding member 50 located on the opposite side to the thrust collar 30 across the key 40 in the axial direction holds the key 40 from radially outside. The holding member 50 is fixed to the shaft 2 by shrink fitting, for example.

However, in order to stably hold the key 40 against a centrifugal force acting on the key 40 by a rotation of the shaft 2 and bending deformation of the shaft 2, a sufficient fastening force between the holding member 50 and the shaft 2 is necessary.

However, if, an axial length of a fastening section between the holding member 50 and the shaft 2 is increased to obtain the sufficient fastening force, the axial length of the shaft 2 increases, which is unfavorable in terms of shaft variation, possible upsizing of the compressor 20, and the like.

The force will be described again which acts on each part of the compressor 20 when the shaft 2 is moved in the axial direction by the thrust force as described above.

In the compressor 20 according to some embodiments, for example, a thrust force Fs toward the right side in FIG. 2 acts. While the thrust force Fs moves the shaft 2 to the right side in the drawing along the axial direction, the side surface 32 of the thrust collar 30 is brought into sliding contact with the side surface 261 of the wheel gear 26 on the left side in the drawing, and thus the thrust collar 30 receives a reaction force Fr along the axial direction from the wheel gear 26. Thus, the thrust collar 30 presses the key 40 toward the left side in the drawing along the axial direction to shift to the left side in the drawing with respect to the shaft 2 along the axial direction. Further, the key 40 is not moved from the fastening section with the shaft 2 but is deformed by the above-described reaction force Fr received from the wheel gear 26, causing the thrust collar 30 to press the key 40 toward the left side in the drawing along the axial direction. Furthermore, due to bending deformation of the shaft 2, the thrust collar 30 presses the key 40 toward the left side in the drawing along the axial direction.

Thus, since a force F1 with which the thrust collar 30 presses the key 40 toward the left side in the drawing along the axial direction acts on the key 40, the key 40 presses the second wall portion 206 toward the left side in the drawing along the axial direction. For descriptive convenience, an axial pressing force with which the key 40 presses the second wall portion 206 will be referred to as a force F2.

Further, with the above-described force F1 acting on the key 40, the key 40 is deformed and presses the holding member 50 toward the left side in the drawing along the axial direction. The centrifugal force of the key 40 also acts on the holding member 50, in addition to a centrifugal force acting on the holding member 50.

A force F3 applied to the holding member 50 radially outward acts so as to reduce the fastening force with the shaft 2 by shrink fitting. A force F4 applied to the holding member 50 in the axial direction shifts the holding member 50 in the axial direction.

Thus, in the compressor 20 according to some embodiments, as will be described later, in a region R (see FIG. 3A) on the opposite side to the thrust collar 30 across the key 40 in the axial direction, a defective portion 100 is provided on one of the outer circumferential surface 201 of the shaft 2, or a surface of the shaft 2 along the radial direction or a surface of the holding member 50 along the radial direction, or at least a part of a section having the surface along the radial direction described above is formed by a material having a Young's modulus lower than a Young's modulus in another section.

As will be described later, in a case where the above-described defective portion 100 is provided for the shaft 2, of the wall portions 205, 206 constituting the key groove 203, the second wall portion 206 on the opposite side to the thrust collar 30 across the key 40 in the axial direction is decreased in rigidity, as compared with a case without the above-described defective portion 100. Thus, with the thrust force (above-described force F2) received from the key 40 and the thrust force (above-described force F4) received via the holding member 50, the second wall portion 206 is easily moved toward the opposite side (left side in FIG. 2) together with the key 40 and the holding member 50.

As will be described later, in a case where the above-described defective portion 100 is provided on the surface of the holding member 50 along the radial direction, the rigidity of the section having the surface is decreased, as compared with a case without the above-described defective portion 100. Thus, the first region 51 of the holding member 50 is easily bent by the thrust force (above-described force F4) received from the key 40, and thus the key is easily bent toward the opposite side (left side in FIG. 2).

Further, as will be described later, if at least a part of a section with the surface of the shaft 2 along the radial direction or the surface of the holding member 50 along the radial direction existing in the above-described region R is formed by the material having the Young's modulus lower than the Young's modulus in the another section, the rigidity of the section having the above-described surface is decreased. Thus, with the thrust force received from the key 40, the section is easily moved toward the opposite side to the thrust collar 30 across the key 40 in the axial direction together with the key 40.

Unless the thrust collar 30 causes a positional shift, the key 40 escapes into the opposite side, decreasing the thrust force received by the key 40 from the thrust collar 30. Thus, the thrust force (above-described force F4) acting on the holding member 50 from the key 40 is relaxed, making it hard for the holding member 50 to cause the positional shift with respect to the shaft 2. Thus, it is possible to suppress the axial length of the fastening section between the holding member 50 and the shaft 2, making it possible to suppress the increase in axial length of the shaft 2, which contributes to suppression of shaft variation and downsizing of the compressor 20.

(Defective Portion 100)

Hereinafter, details of the above-described defective portion 100 will be described.

As described above, the defective portion 100 according to some embodiments is the configuration for decreasing the rigidity of the second wall portion 206, if provided for the shaft 2.

More specifically, the defective portion 100 according to an embodiment may be a small diameter portion 208 formed on the outer circumferential surface 201 of the shaft 2 in the above-described region R and having an outer diameter D2 smaller than an outer diameter D1 of the shaft 2 at a position where the thrust collar 30 is disposed.

By providing the above-described small diameter portion 208 for the above-described region R, it is possible to reduce an axial thickness of the second wall portion 206, allowing the second wall portion 206 to bend toward the side of the small diameter portion 208. Thus, with the thrust force received from the key 40, the second wall portion 206 is easily moved together with the key 40 and the holding member 50.

The small diameter portion 208 may have an outer diameter not greater than an outer diameter D3 of the shaft 2 on a bottom surface 203a of the key groove 203. FIG. 3B shows an example of a case where the small diameter portion 208 has an outer diameter smaller than the outer diameter D3 of the shaft 2 on the bottom surface 203a of the key groove 203.

Thus, it is possible to effectively decrease the rigidity of the second wall portion 206, and the second wall portion 206 easily bends toward the side of the small diameter portion 208. Thus, with the thrust force received from the key 40, the second wall portion 206 is moved toward the side of the small diameter portion 208 together with the key 40 and the holding member 50 more easily.

The defective portion 100 according to an embodiment may be a recess 209 which is formed in, of the surface of the shaft 2 along the radial direction in the above-described region R, a surface continued to an outer circumferential surface 208a of the small diameter portion 208, that is, a side wall surface 206b of the second wall portion 206 directed toward an axially opposite side to the second key groove wall surface 206a.

The side wall surface 206b also serves as a stepped surface connecting the outer circumferential surface 201 of the shaft 2 and the outer circumferential surface 208a of the small diameter portion 208 which are different in diameter.

The recess 209 preferably has a circumferential size which is larger than a radial size of the recess 209. Further, the recess 209 may be formed over the entire circumference of the side wall surface 206b, or may be disposed in a portion along the circumferential direction.

Thus, the second wall portion 206 bends toward the side of the small diameter portion 208 more easily. Thus, with the thrust force received from the key 40, the second wall portion 206 is moved toward the side of the small diameter portion 208 together with the key 40 and the holding member 50 more easily.

The second wall portion 206 is easily inclined in a case where the recess 209 is disposed in a radially inner region of the side wall surface 206b, compared with a case where the recess 209 is disposed in a radially outer region of the side wall surface 206b.

Further, although not illustrated, the recess 209 may be disposed not in the side wall surface 206b but in the second key groove wall surface 206a, or may be disposed in the side wall surface 206b and the second key groove wall surface 206a.

The defective portion 100 according to an embodiment may be the wall defective region 207 as shown in FIG. 4.

With the wall defective region 207, the second wall portion 206 easily bends toward the side of the small diameter portion 208 as compared with a case without the wall defective region 207. Thus, with the thrust force received from the key 40, the second wall portion 206 is easily moved toward the side of the small diameter portion 208 together with the key 40 and the holding member 50.

The defective portion 100 according to an embodiment may be a plurality of grooves 211 which are formed in the outer circumferential surface 201 of the shaft 2 in the above-described region R, extend from the key groove 203 toward the opposite side to the thrust collar along the axial direction, and are formed at intervals in the circumferential direction, as shown in FIG. 5.

Thus, as compared with a case without the grooves 211, the second wall portion 206 is decreased in rigidity and is easily deformed toward the opposite side to the thrust collar 30. Thus, with the thrust force received from the key 40, the second wall portion 206 is easily moved toward the opposite side to the thrust collar 30 together with the key 40 and the holding member 50.

As described above, the defective portion 100 according to some embodiments is the configuration for decreasing the rigidity of the section with the surface of the holding member 50 along the radial direction existing in the above-described region R, if provided for the holding member 50.

More specifically, the defective portion 100 according to an embodiment may be recesses 53 formed in the first end surface 51a and the second end surface 51b each of which is the surface of the holding member 50 and is the surface of the above-described region R along the radial direction. The recess 53 formed in the first end surface 51a may be referred to as a first recess 53a, and the recess 53 formed in the second end surface 51b may be referred to as a second recess 53b.

The recess 53 is preferably disposed in at least one of the first end surface 51a or the second end surface 51b.

Thus, a section including the first end surface 51a and the second end surface 51b of the holding member 50, that is, the first region 51 easily bends toward the opposite side to the thrust collar 30. Thus, the key 40 receiving the thrust force from the thrust collar 30 is easily deformed by the thrust force (above-described force F1). The key 40 is deformed and escapes into the opposite side, decreasing the thrust force (above-described force F1) received by the key 40 from the thrust collar 30. Thus, the thrust force (above-described force F4) acting on the holding member 50 from the key 40 is relaxed, making it hard for the holding member 50 to cause the positional shift with respect to the shaft 2.

(Regarding Configuration Formed by Material Having Low Young's Modulus)

In the compressor 20 according to some embodiments, of the section with the surface of the shaft 2 along the radial direction existing in the above-described region R, the wall portion (second wall portion 206) forming the side wall of the key groove 203 may be formed by the material having the Young's modulus lower than the Young's modulus in another section.

As one of methods for forming the second wall portion 206 by the material having the Young's modulus lower than the Young's modulus in the another section, it is possible to give, for example, a method for forming the second wall portion 206 on the shaft 2 by an additive manufacturing method with metallic powder having the Young's modulus lower than the Young's modulus in the another section.

Thus, the rigidity of the second wall portion 206 is decreased relative to the another section. Therefore, with the thrust force received from the key 40, the second wall portion 206 is easily moved toward the opposite side to the thrust collar 30 together with the key 40.

In the compressor 20 according to some embodiments, of the holding member 50, a section with the first end surface 51a and the second end surface 51b each of which is at least the surface of the holding member 50 along the radial direction existing in the above-described region R, that is, the first region 51 may be formed by the material having the Young's modulus lower than the Young's modulus in the another section.

Thus, the rigidity of at least the first region 51 of the holding member 50 is decreased. Therefore, the first region 51 is easily bent toward the opposite side to the thrust collar 30. Thus, the key 40 receiving the thrust force from the thrust collar 30 is easily deformed by the thrust force (above-described force F1). The key 40 is deformed and escapes into the opposite side, decreasing the thrust force (above-described force F1) received by the key 40 from the thrust collar 30. Thus, the thrust force (above-described force F4) acting on the holding member 50 from the key 40 is relaxed, making it hard for the holding member 50 to cause the positional shift with respect to the shaft 2.

The present disclosure is not limited to the above-described embodiments, and also includes an embodiment obtained by modifying the above-described embodiments and an embodiment obtained by combining these embodiments as appropriate.

That is, in the compressor 20 according to some embodiments described above, at least one of the above-described defective portions 100 and at least one of the embodiments formed by the material having the low Young's modulus described above may be implemented.

Further, in some embodiments described above, the geared compressor has been described as an example of the rotary machine 1. However, the present disclosure is not limited to the geared compressor, as long as the rotary machine has a thrust load acting on a shaft, and the above-described contents may be applied to other kinds of rotary machines such as a turbocharger.

The contents described in the above embodiments would be understood as follows, for instance.

(1) A rotary machine 1 according to at least one embodiment of the present disclosure includes a shaft 2 extending along an axial direction, a thrust collar 30 disposed on an outer circumferential side of the shaft 2, a key 40 which engages with a key groove 203 formed in an outer circumferential surface 201 of the shaft 2 and is disposed adjacent to the thrust collar 30 in the axial direction, and a holding member 50 located on an opposite side to the thrust collar across the key 40 in the axial direction, for holding the key 40 from radially outside. The rotary machine 1 according to at least one embodiment of the present disclosure is configured such that, in a region R on the opposite side to the thrust collar 30 across the key 40 in the axial direction, a defective portion 100 is provided on one of the outer circumferential surface 201 of the shaft 2, or a surface (such as a second key groove wall surface 206a, a side wall surface 206b, a first end surface 51a, a second end surface 51b) of the shaft 2 along a radial direction or a surface (such as a second key groove wall surface 206a, a side wall surface 206b, a first end surface 51a, a second end surface 51b) of the holding member 50 along the radial direction, or at least a part of a section (such as a second wall portion 206, a first region 51) having the surface (such as the second key groove wall surface 206a, the side wall surface 206b, the first end surface 51a, the second end surface 51b) along the radial direction described above is formed by a material having a Young's modulus lower than a Young's modulus in another section.

With the above configuration (1), it is possible to suppress the axial length of the fastening section between the holding member 50 and the shaft 2, making it possible to suppress the increase in axial length of the shaft 2, which contributes to suppression of shaft variation and downsizing of the compressor 20.

(2) In some embodiments, in the above configuration (1), the defective portion 100 preferably includes a small diameter portion 208 formed on the outer circumferential surface 201 of the shaft 2 in the above-described region R and having an outer diameter D2 smaller than an outer diameter D1 of the shaft 2 at a position where the thrust collar 30 is disposed.

With the above configuration (2), providing the above-described small diameter portion 208, of the wall portions 205, 206 constituting the key groove 203, the wall portion (second wall portion 206) on the opposite side to the thrust collar 30 across the key 40 in the axial direction is decreased in rigidity, and the second wall portion 206 easily bends toward the opposite side. Thus, with the thrust force received from the key 40, the second wall portion 206 is easily moved toward the opposite side together with the key 40 and the holding member 50.

(3) In some embodiments, in the above configuration (2), the small diameter portion 208 preferably has an outer diameter not greater than an outer diameter D3 of the shaft 2 on a bottom surface 203a of the key groove 203.

With the above configuration (3), of the wall portions 205, 206 constituting the key groove 203, the wall portion (second wall portion 206) on the opposite side to the thrust collar across the key 40 in the axial direction is effectively decreased in rigidity, and the second wall portion 206 easily bends toward the opposite side. Thus, with the thrust force received from the key 40, the second wall portion 206 is moved toward the opposite side together with the key 40 and the holding member 50 more easily.

(4) In some embodiments, in the above configuration (2) or (3), the defective portion 100 preferably includes a recess 209 which is formed in, of the above-described surface (such as the second key groove wall surface 206a, the side wall surface 106b) of the shaft 2 along the radial direction, a surface (side wall surface 206b) continued to an outer circumferential surface 208a of the small diameter portion 208.

With the above configuration (4), of the wall portions 205, 206 constituting the key groove 203, the wall portion (second wall portion 206) on the opposite side to the thrust collar across the key 40 in the axial direction bends toward the opposite side more easily. Thus, with the thrust force received from the key 40, the second wall portion 206 is moved toward the opposite side together with the key 40 and the holding member 50 more easily.

(5) In some embodiments, in any one of the above configurations (1) to (4), the defective portion 100 preferably includes a recess 53 which is formed in the above-described surface (such as the first end surface 51a, the second end surface 51b) of the holding member 50 along the radial direction.

With the above configuration (5), a section (first region 51) including the above-described surface (such as the first end surface 51a, the second end surface 51b) of the holding member 50 easily bends toward the opposite side to the thrust collar 30. Thus, the key 40 receiving the thrust force from the thrust collar 30 is easily deformed by the thrust force. The key 40 is deformed and escapes into the opposite side, decreasing the thrust force received by the key 40 from the thrust collar 30. Thus, with the above configuration (5), the thrust force acting on the holding member 50 from the key 40 is relaxed, making it hard for the holding member 50 to cause the positional shift with respect to the shaft 2.

(6) In some embodiments, in any one of the above configurations (1) to (5), the defective portion 100 preferably includes a plurality of grooves 211 which are formed in the outer circumferential surface 201 of the shaft 2, extend from the key groove 203 toward the above-described opposite side along the axial direction, and are formed at intervals in a circumferential direction.

With the above configuration (6), as compared with the case without the above-described grooves 211, of the wall portions 205, 206 constituting the key groove 203, the wall portion (second wall portion 206) on the opposite side to the thrust collar 30 across the key 40 in the axial direction is decreased in rigidity, and the second wall portion 206 easily bends toward the opposite side. Thus, with the thrust force received from the key 40, the second wall portion 206 is easily moved toward the opposite side together with the key 40 and the holding member 50.

(7) In some embodiments, in any one of the above configurations (1) to (6), of the section (second wall portion 206) having the above-described surface (such as the second key groove wall surface 206a, the side wall surface 206b) of the shaft 2 along the radial direction, a wall portion (second wall portion 206) forming a side wall of the key groove 203 may be formed by the material having the Young's modulus lower than the Young's modulus in the above-described another section.

With the above configuration (7), of the section (second wall portion 206) having the above-described surface (such as the second key groove wall surface 206a, the side wall surface 206b) of the shaft 2 along the radial direction, the wall portion (second wall portion 206) forming the side wall of the key groove 203 is decreased in rigidity. Thus, with the thrust force received from the key 40, the second wall portion 206 is easily moved toward the opposite side together with the key 40

(8) In some embodiments, in any one of the above configurations (1) to (7), of the holding member 50, the section (first region 51) having at least the above-described surface (such as the first end surface 51a, the second end surface 51b) of the holding member 50 along the radial direction may be formed by the material having the Young's modulus lower than the Young's modulus in the above-described another section.

With the above configuration (8), of the holding member 50, the section (first region 51) having at least the above-described surface (such as the first end surface 51a, the second end surface 51b) of the holding member 50 along the radial direction is decreased in rigidity. Thus, the section (first region 51) including the above-described surface (such as the first end surface 51a, the second end surface 51b) of the holding member 50 easily bends toward the opposite side to the thrust collar 30. Thus, the key 40 receiving the thrust force from the thrust collar 30 is easily deformed by the thrust force. The key 40 is deformed and escapes into the opposite side, decreasing the thrust force received by the key 40 from the thrust collar 30. Thus, with the above configuration (8), the thrust force acting on the holding member 50 from the key 40 is relaxed, making it hard for the holding member 50 to cause the positional shift with respect to the shaft 2.

(9) A geared compressor 20 according to at least one embodiment of the present disclosure has the configuration according to any one of the above configurations (1) to (8).

With the above configuration (9), it is possible to suppress the axial length of the fastening section between the holding member 50 and the shaft 2, making it possible to suppress the increase in axial length of the shaft 2, which contributes to suppression of shaft variation and downsizing of the geared compressor 20.

1. A rotary machine, comprising:
a shaft extending along an axial direction;
a thrust collar disposed on an outer circumferential side of the shaft;
a key which engages with a key groove formed in an outer circumferential surface of the shaft and is disposed adjacent to the thrust collar in the axial direction; and
a holding member located on an opposite side to the thrust collar across the key in the axial direction, for holding the key from radially outside,
wherein, in a region on the opposite side to the thrust collar across the key in the axial direction, a defective portion is provided on one of the outer circumferential surface of the shaft, or a surface of the shaft along a radial direction or a surface of the holding member along the radial direction, or at least a part of a section having the surface along the radial direction is formed by a material having a Young's modulus lower than a Young's modulus in another section.

2. The rotary machine according to claim 1,
wherein the defective portion includes a small diameter portion formed on the outer circumferential surface of the shaft in the region and having an outer diameter smaller than an outer diameter of the shaft at a position where the thrust collar is disposed.

3. The rotary machine according to claim 2,
wherein the small diameter portion has an outer diameter not greater than an outer diameter of the shaft on a bottom surface of the key groove.

4. The rotary machine according to claim 2,
wherein the defective portion includes a recess which is formed in, of the surface of the shaft along the radial direction, a surface continued to an outer circumferential surface of the small diameter portion.

5. The rotary machine according to claim 1,
wherein the defective portion includes a recess which is formed in the surface of the holding member along the radial direction.

6. The rotary machine according to any claim 1,
wherein the defective portion includes a plurality of grooves which are formed in the outer circumferential surface of the shaft, extend from the key groove toward the opposite side along the axial direction, and are formed at intervals in a circumferential direction.

7. The rotary machine according to claim 1,
wherein, of the section having the surface of the shaft along the radial direction, a wall portion forming a side wall of the key groove is formed by the material having the Young's modulus lower than the Young's modulus in the another section.

8. The rotary machine according to claim 1,
wherein, of the holding member, the section having at least the surface of the holding member along the radial direction is formed by the material having the Young's modulus lower than the Young's modulus in the another section.

9. A geared compressor having the configuration according to claim 1.
